(19) United States
(12) Patent Application Publication
(10) Pub. No.: US 2011/0310034 A1
(43) Pub. Date: Dec. 22, 2011

(54) INFORMATION PROCESSING APPARATUS, INFORMATION PROCESSING METHOD, AND COMPUTER PROGRAM PRODUCT

(75) Inventors: Kazushige Ouchi, Saitama (JP); Miwako Doi, Kanagawa (JP); Naoki Iketani, Tokyo (JP); Yuka Kobayashi, Aichi (JP); Kazunori Imoto, Kanagawa (JP); Tomonori Senoo, Tokyo (JP)

(73) Assignee: KABUSHIKI KAISHA TOSHIBA, Tokyo (JP)

(21) Appl. No.: 13/052,796

(22) Filed: Mar. 21, 2011

(30) Foreign Application Priority Data
Jun. 16, 2010 (JP) 2010-137756

(51) Int. Cl. G06F 3/041

(52) U.S. Cl. 345/173

(57) ABSTRACT

According to an embodiment, an information processing apparatus includes a detecting unit that detects an operation to first and second touch panels respectively provided above first and second display; a determining unit that determines, when the detecting unit detects a selection operation for selecting a region of a screen on the first display using the first touch panel, kind of an object in a selected region; a generating unit that generates an application list including application candidates to be started to open the object according to the kind; a display controller that displays, when the detecting unit detects a transmission operation for transmitting the selected region to the second display using the first touch panel, the application list on the second display; and an application controller that starts, when the detecting unit detects a selection operation for selecting any one of the applications, a selected application.

### CROSS-REFERENCE TO RELATED APPLICATION(S)

This application is based upon and claims the benefit of priority from Japanese Patent Application No. 2010-137756, filed on Jun. 16, 2010; the entire contents of which are incorporated herein by reference.

### FIELD

Embodiments described herein relate generally to an information processing apparatus, an information processing method, and a computer program product.

### BACKGROUND

In recent years, with a reduction in the size of an information processing apparatus, an information processing apparatus that uses a touch panel display for operations instead of a keyboard has come into widespread use. In addition, there is an information processing apparatus of a two-screen type, such as a two-screen spread type, in which touch panel displays are used as two displays.

However, in the related art, since a connecting portion is provided between two screens, an operation performed between a plurality of screens needs to be improved.

### BRIEF DESCRIPTION OF THE DRAWINGS

FIG. 1 is a diagram schematically illustrating the unfolded state of an information processing apparatus according to a first embodiment;

FIG. 2 is a diagram schematically illustrating the half-opened state of the information processing apparatus according to the first embodiment;

FIG. 3 is a diagram schematically illustrating the folded state of the information processing apparatus according to the first embodiment;

FIG. 4 is a block diagram illustrating the information processing apparatus according to the first embodiment;

FIG. 5 is a diagram illustrating a display mode of an icon before a selection operation ends;

FIG. 6 is a diagram illustrating a display mode of the icon after the selection operation ends;

FIG. 7 is a diagram illustrating a display mode of text before a selection operation ends;

FIG. 8 is a diagram illustrating a display mode of the text after the selection operation ends;

FIG. 9 is a diagram illustrating a display mode of an image before a selection operation ends;

FIG. 10 is a diagram illustrating a display mode of the image after the selection operation ends;

FIG. 11 is a diagram illustrating a display mode after an icon transmission operation;

FIG. 12 is a diagram illustrating a display mode after a text transmission operation;

FIG. 13 is a diagram illustrating a display mode after an image transmission operation;

FIG. 14 is a diagram illustrating an application list table;

FIG. 15 is a diagram illustrating a display mode of the application list of text;

FIG. 16 is a flowchart illustrating an example of an activating process of the information processing apparatus according to the first embodiment;

FIG. 17 is a block diagram illustrating an information processing apparatus according to a second embodiment;

FIG. 18 is a diagram illustrating a display mode of the application list of text;

FIG. 19 is a diagram illustrating the activate result of text by an application;

FIG. 20 is a flowchart illustrating an example of an activating process of the information processing apparatus according to the second embodiment;

FIG. 21 is a diagram illustrating the hardware configuration of the information processing apparatuses according to the first and second embodiments;

FIG. 22 is a diagram illustrating a retention region according to a modification;

FIG. 23 is a diagram illustrating a retention region according to a modification;

FIG. 24 is a diagram illustrating a retention region according to a modification; and

FIG. 25 is a diagram illustrating an application list table according to a modification.

### DETAILED DESCRIPTION

According to an embodiment, an information processing apparatus includes a first display; a first touch panel above a display surface of the first display; a second display; a second touch panel above a display surface of the second display; a detecting unit configured to detect an operation input to the first touch panel and the second touch panel; a determining unit configured to, when the detecting unit detects as the operation input a selection operation for selecting a region of a screen displayed on the first display using the first touch panel, determine kind of an object included in a selected region; a generating unit configured to generate an application list including application candidates to be started in order to open the object according to the kind of the object; a display control unit configured to, when the detecting unit detects as the operation input a transmission operation for transmitting the selected region to the second display using the first touch panel, display the application list on the second display; and an application control unit configured to, when the detecting unit detects as the operation input a selection operation for selecting any one of the applications included in the application list using the second touch panel, start a selected application to open the object.

Various embodiments will be described hereinafter with reference to the accompanying drawings.

### First Embodiment

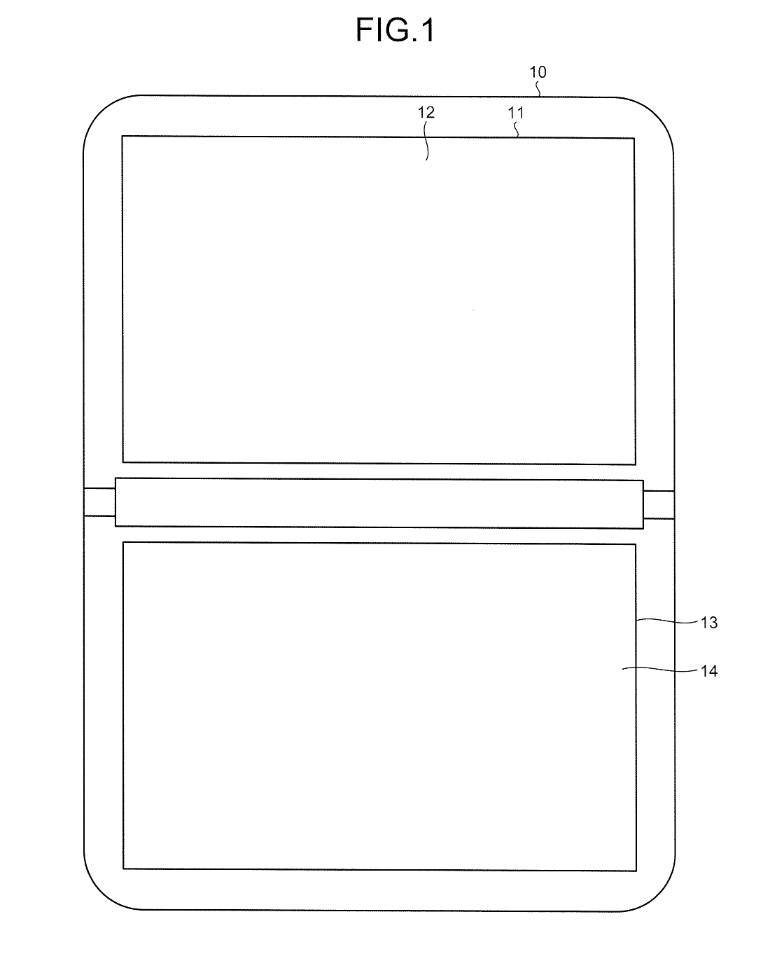

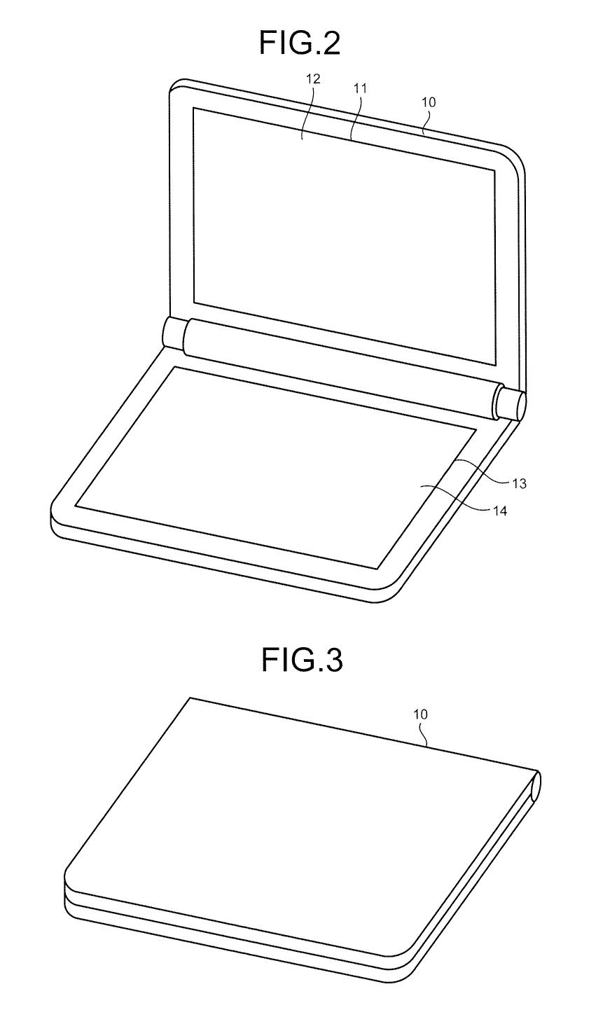

FIG. 1 is a diagram schematically illustrating the opened state of an example of an information processing apparatus 10 according to a first embodiment. FIG. 2 is a diagram illustrating the half-opened state of an example of the information processing apparatus 10 according to the first embodiment. FIG. 3 is a diagram schematically illustrating the closed state of an example of the information processing apparatus 10 according to the first embodiment. The information processing apparatus 10 is a laptop PC (Personal Computer) having a double screen structure and includes a first display unit 11 and a second display unit 13. The first display unit 11 and the second display unit 13 include a first touch panel unit 12 and a second touch panel unit 14, respectively. That is, in the information processing apparatus 10, it is assumed that both screens are implemented by touch panel displays and the user touches both screens with the fingers to operate the information processing apparatus 10.

In the first embodiment, an example will be described in which the first display unit 11 is mainly used to browse content and the second display unit 13 is mainly used to input characters or perform a search operation. In this case, a software keyboard is displayed on the second display unit 13, so that the user touches the second touch panel unit 14 with the fingers to input characters one by one. When a search is performed using the characters input to the second touch panel unit 14 as a keyword, the search result is displayed on the first display unit 11. However, the main purpose of the first display unit 11 and the main purpose of the second display unit 13 may be reversed. In addition, the first and second display units may be used in other ways.

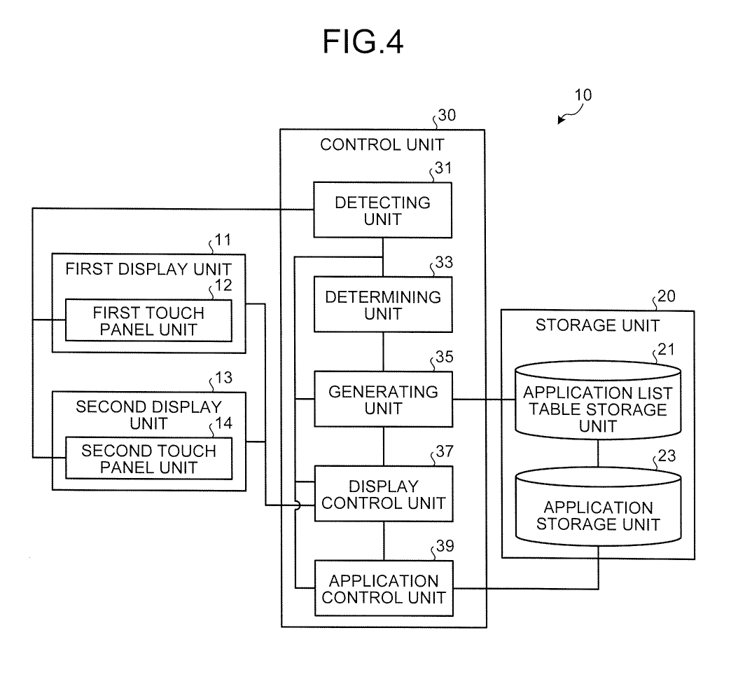

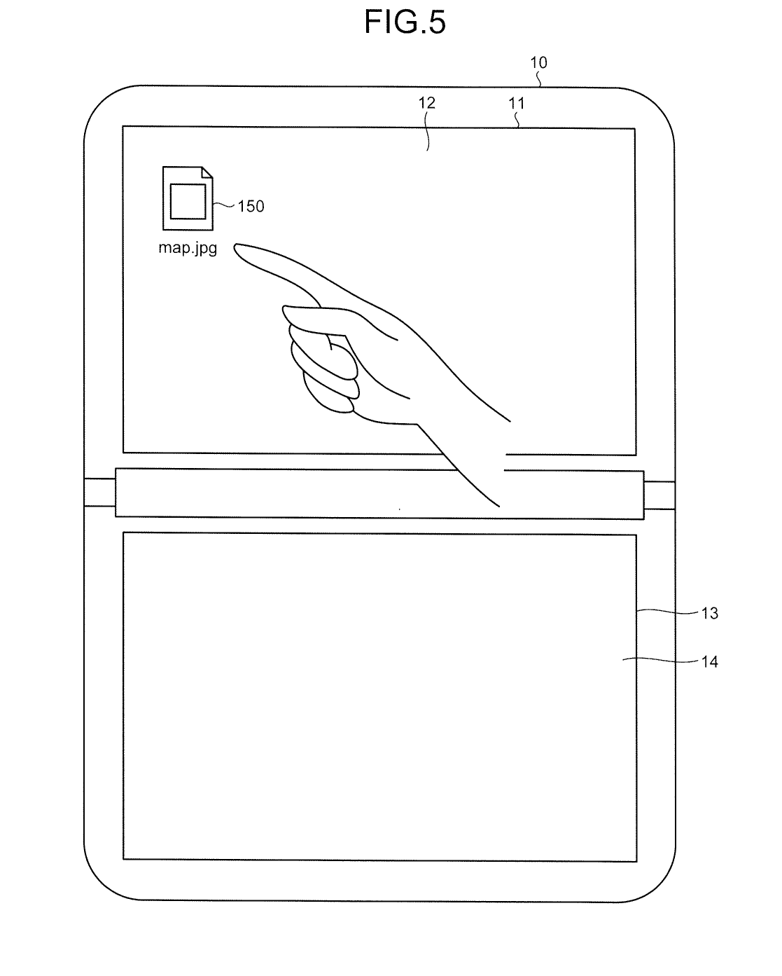

FIG. 4 is a block diagram illustrating an example of the structure of the information processing apparatus 10 according to the first embodiment. The information processing apparatus 10 includes the first display unit 11 having the first touch panel unit 12, the second display unit 13 having the second touch panel unit 14, a storage unit 20, and a control unit 30.

The first display unit 11 and the second display unit 13 display various kinds of screens and may be, for example, the existing display devices such as liquid crystal displays (LCD).

The user performs various kinds of input operations on the first touch panel unit 12 and the second touch panel unit 14 with the fingers or a dedicated pen. For example, the first touch panel unit 12 and the second touch panel unit 14 may be any one of a capacitance type, a resistive type, and an electromagnetic induction type. When the first touch panel unit 12 and the second touch panel unit 14 are a capacitance type and a resistive type, they may be operated by the finger or a stylus. When the first touch panel unit 12 and the second touch panel unit 14 are an electromagnetic induction type, they may be operated by a dedicated pen.

The first touch panel unit 12 is arranged on a display surface of the first display unit 11. The second touch panel unit 14 is arranged on a display surface of the second display unit 13. With this structure, points on the screens displayed on the first display unit 11 and the second display unit 13 are directly designated by the finger or the pen. That is, an intuitive operational feeling is obtained.

The storage unit 20 stores therein, for example, various kinds of programs executed in the information processing apparatus 10 or data used in various kinds of processes performed in the information processing apparatus 10. The storage unit 20 may be implemented by at least one of the existing storage media that can magnetically, electrically, or optically store data, such as an HDD (Hard Disk Drive), an SSD (Solid State Drive), a memory card, an optical disk, a ROM (Read Only Memory), and a RAM (Random Access Memory). The storage unit 20 includes an application list table storage unit 21 and an application storage unit 23. The storage units will be described in detail below.

The control unit 30 controls each unit of the information processing apparatus 10 and may be implemented by the existing control device, such as a CPU (Central Processing Unit) or a GPU (Graphics Processing Unit). The control unit 30 includes a detecting unit 31, a determining unit 33, a generating unit 35, a display control unit 37, and an application control unit 39.

The detecting unit 31 detects an operation input to the first touch panel unit 12 and the second touch panel unit 14. Specifically, the detecting unit 31 sequentially acquires coordinate information indicating an operation (touch) position from the operated touch panel unit and detects the kind of operation using the acquired coordinate information. For example, when a variation in the position in the sequentially acquired coordinate information is small, the detecting unit 31 detects the input operation as a selection operation. For example, when the variation in the position in the sequentially acquired coordinate information is equal to or more than a predetermined speed and the operation (touch) time is equal to or less than a predetermined period of time, the detecting unit 31 detects the input operation as a transmission operation.

The “transmission operation” means an operation of flicking a finger on the screen and is, for example, an operation input to move the selected content in a finger movement direction. For example, in FIG. 5, when an icon 150 is to be transmitted from the first display unit 11 to the second display unit 13, the user touches a point on the first touch panel unit 12 corresponding to the display position of the selected icon 150 with a fingertip, rapidly moves the fingertip to the second display unit 13, and takes the fingertip off the first touch panel unit 12 within a predetermined period of time. The detecting unit 31 detects the transmission operation as follows. The detecting unit 31 detects a series of operations as the transmission operation to the second display unit 13 in the following cases: the touch of the selected icon 150 is detected; a variation in the coordinates of a touch point is detected; a variation in the coordinates in the direction to the second display unit 13 is more than a predetermined value; and a touch with the first touch panel unit 12 is not detected within a predetermined period of time.

When the detecting unit 31 detects a selection operation for selecting a region of the screen displayed on the first display unit 11 using the first touch panel unit 12, the determining unit 33 determines the attribute of the selected region. The “attribute” indicates the kind of object in the selected region and includes, for example, an icon (file/folder), text, or an image. The determining unit 33 determines the attribute on the basis of, for example, the kind of window (application) to which the selected region belongs.

For example, when there is an icon in the selected region, the determining unit 33 determines the attribute of the selected region to be an icon and determines the selected object to be a file or a folder. When there is a text box in the selected region, the determining unit 33 determines the attribute of the selected region to be text and determines the selected object as text (character string). Although detailed explanation is omitted, in the selection of an image, for example, an image selection button (not shown) is pushed and then a region is selected. Therefore, the determining unit 33 determines the attribute of the selected region to be an image and determines the selected object to be an image with the shape and size of the selected region, with reference to the information. The image selection button may be a GUI or a physical switch.

When the attribute of the selected region is an icon, the shape and size of the selected region may be equal to those of the icon. When the attribute of the selected region is text, the shape and size of the selected region may be equal to the display range of the text.

When the detecting unit 31 detects that the selection operation for selecting a region of the screen displayed on the first display unit 11 using the first touch panel unit 12 has ended, the display control unit 37 changes the display mode of the selected region according to the attribute determined by the determining unit 33 and displays the selected region on the first display unit 11.

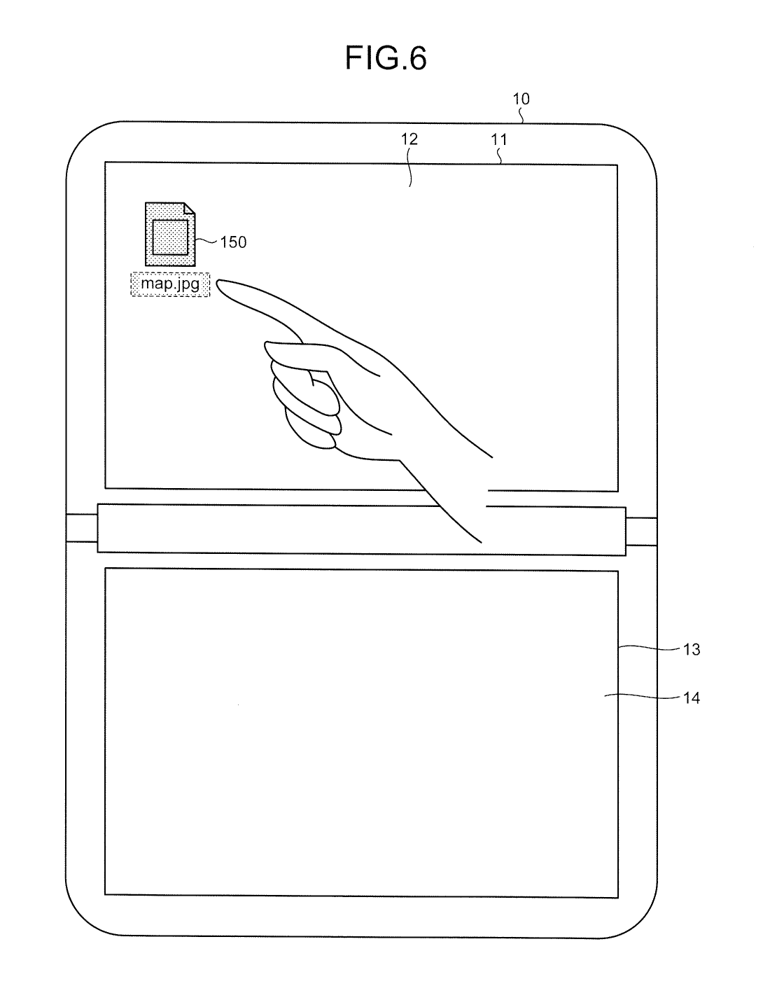

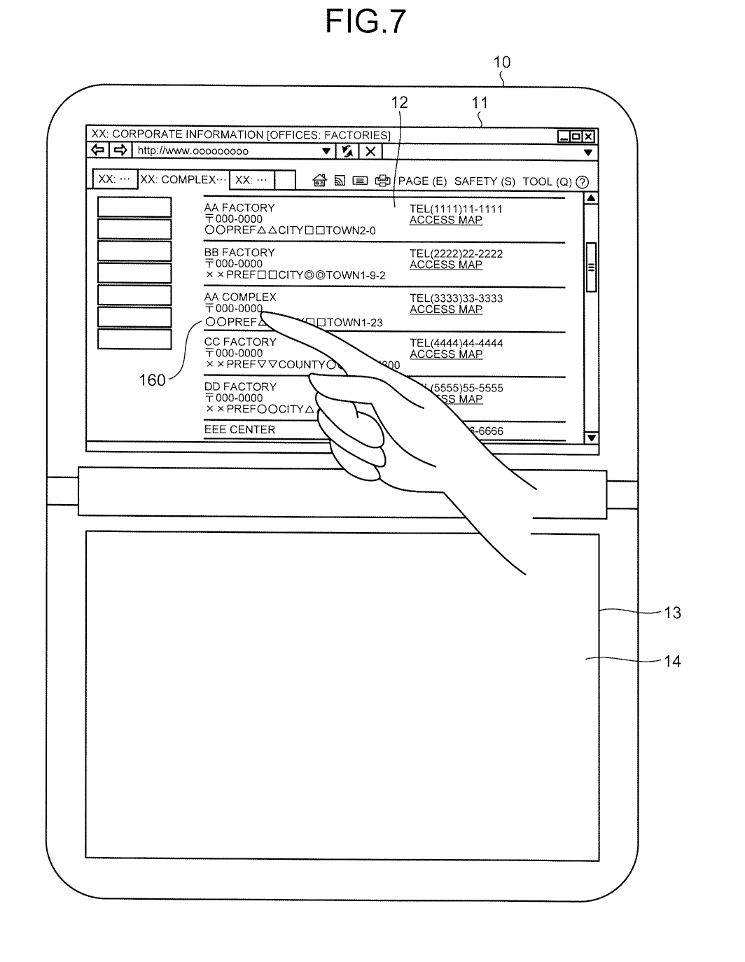

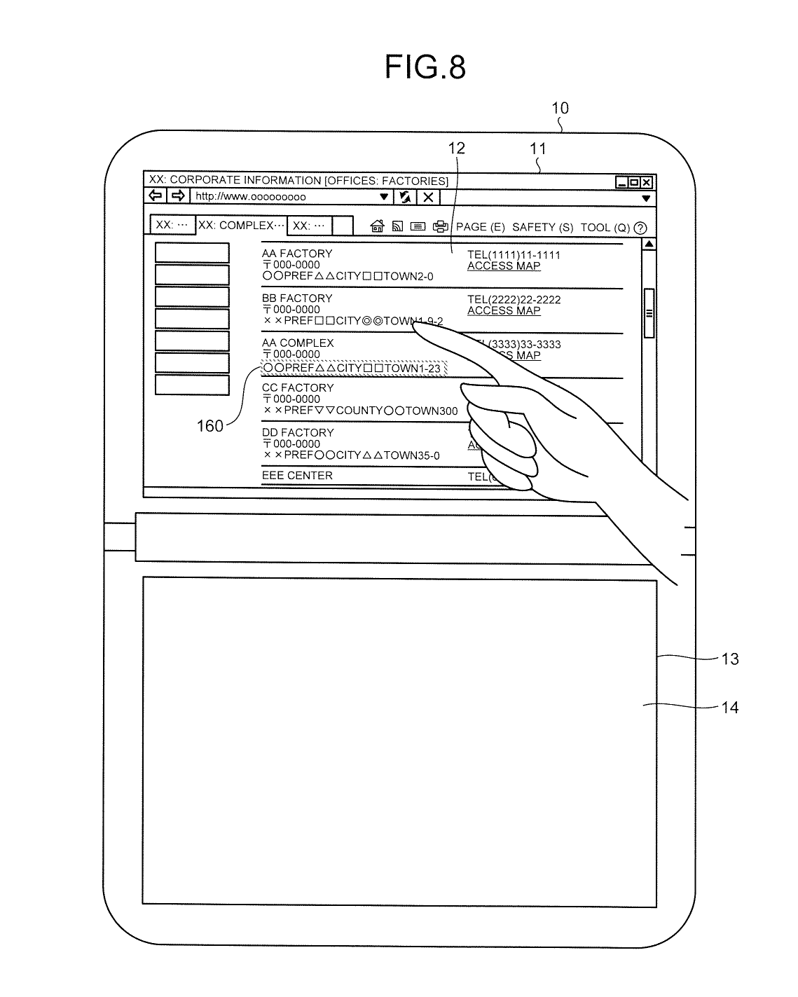

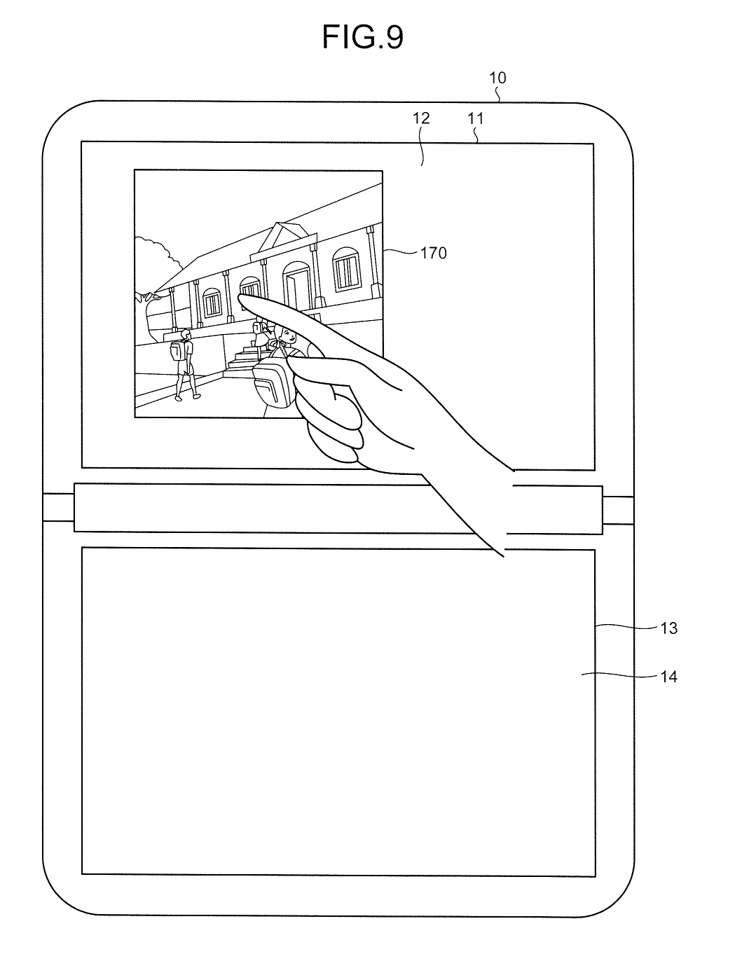

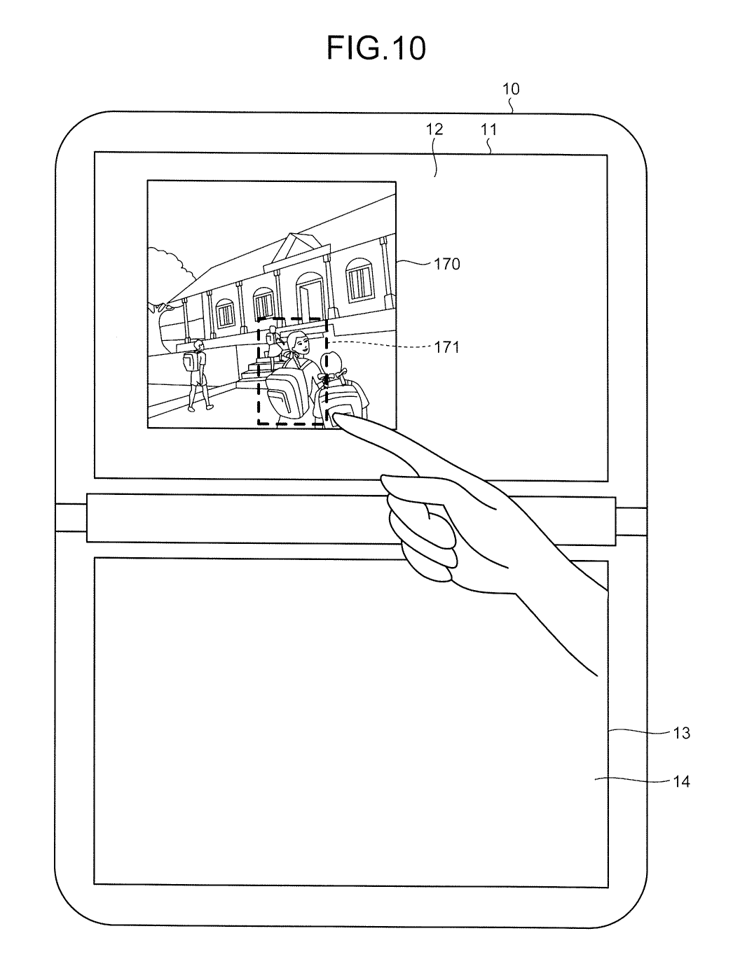

For example, as shown in FIG. 5, when the detecting unit 31 detects a selection operation for selecting the icon 150 displayed on the first display unit 11, the display control unit 37 reverses the color of the icon 150 displayed on the first display unit 11, as shown in FIG. 6. For another example, as shown in FIG. 7, when the detecting unit 31 detects a selection operation for selecting text 160 displayed on the first display unit 11, the display control unit 37 highlights the text 160 displayed on the first display unit 11, as shown in FIG. 8. For still another example, as shown in FIG. 9, when the detecting unit 31 detects a selection operation for selecting a predetermined region in an image 170 displayed on the first display unit 11, the display control unit 37 cuts out a predetermined region 171 selected from the image 170 displayed on the first display unit 11 and displays the selected predetermined region 171 so as to be popped up, as shown in FIG. 10. As a method of selecting a predetermined region in the image 170, the following method may be used: the user touches a starting point and an end point to select a rectangular region having a diagonal line linking the starting point and the end point; and the user traces a region to be selected and selects the traced region. This selection operation is performed after the above-described image selection button is pushed.

When the detecting unit 31 detects a transmission operation for transmitting the selection region to the second display unit 13 on the first touch panel unit 12, the display control unit 37 displays an application list, which will be described hereinafter, on the second display unit 13.

Finally, when the detecting unit 31 detects a transmission operation for transmitting the selected region to the second display unit 13 using the first touch panel unit 12, the display control unit 37 displays the selected region in a retention region 15 displayed on the second display unit 13. In this case, the display control unit 37 may display the original selected region (the selected region displayed on the first display unit 11) without any change or display the original selected region in a cut state.

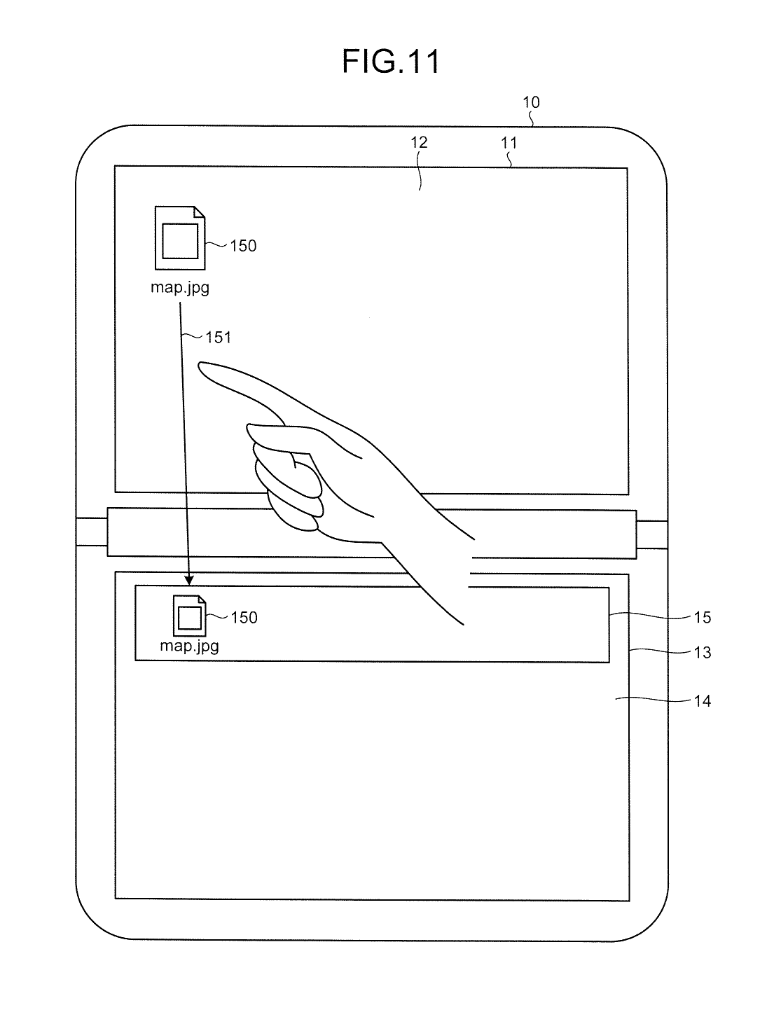

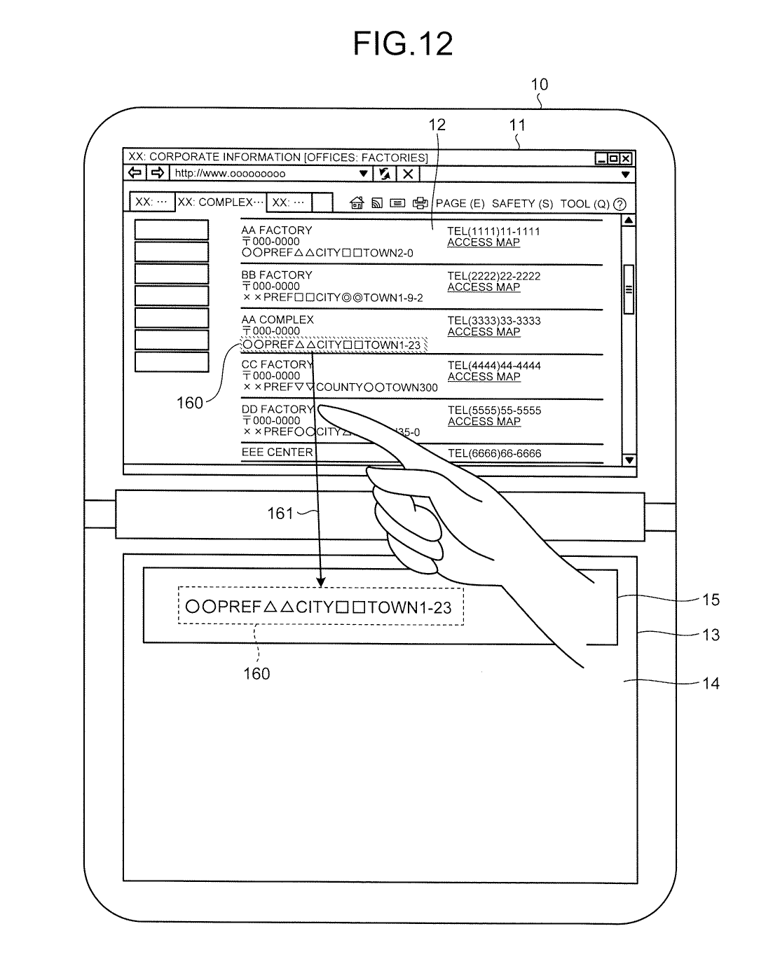

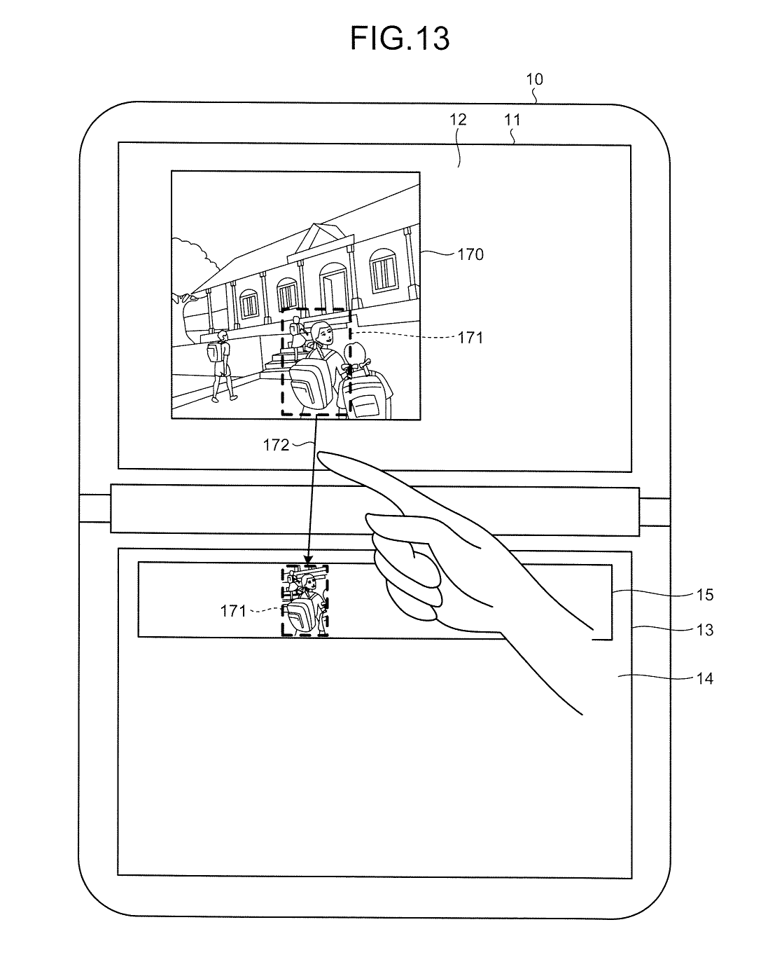

For example, as shown in FIG. 11, when the detecting unit 31 detects a transmission operation for transmitting the icon 150 displayed on the first display unit 11 in the direction of an arrow 151, the display control unit 37 displays the icon 150 in the retention region 15 displayed on the second display unit 13. For another example, as shown in FIG. 12, when the detecting unit 31 detects a transmission operation for transmitting the text 160 displayed on the first display unit 11 in the direction of an arrow 161, the display control unit 37 displays the text 160 in the retention region 15 displayed on the second display unit 13. For still another example, as shown in FIG. 13, when the detecting unit 31 detects a transmission operation for transmitting the predetermined region 171 selected from the image 170 displayed on the first display unit 11 in the direction of an arrow 172, the display control unit 37 displays the predetermined region 171 in the retention region 15 displayed on the second display unit 13.

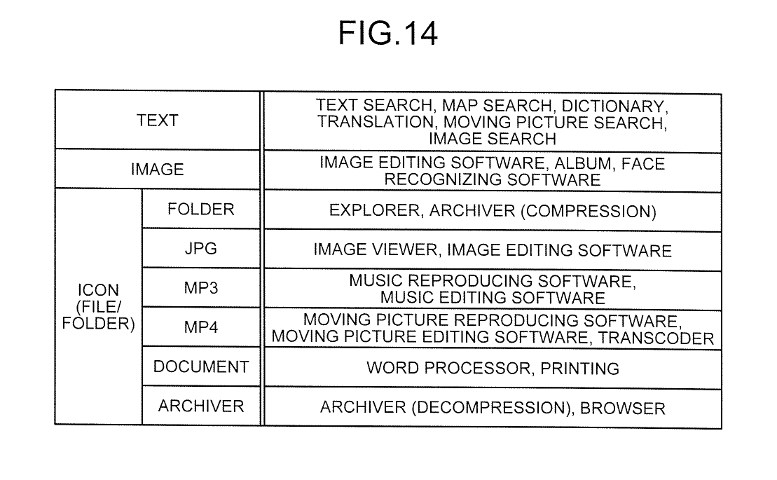

The application list table storage unit 21 stores therein an application list table in which the attribute of the selected region is associated with an application list including application candidates to be started in order to open an object in the selected region. FIG. 14 is a diagram illustrating an example of the application list table. In the example shown in FIG. 14, when the attribute of the selected region is text, that is, when the selected object is text, the applications included in the application list are a text search, a map search, a dictionary, translation, a moving picture search, and an image search. When the attribute of the selected region is an image, that is, when the selected object is an image, the applications included in the application list are image editing software, an album, and face recognizing software. When the attribute of the selected region is an icon, that is, when the selected object is a file/folder, the applications included in the application list are predetermined on the basis of the kind of icon. The kind of icon reflects the kind of file or folder. Therefore, when the selected object is a file/folder, the applications included in the application list are determined on the basis of the kind of file or folder.

For example, when the kind of icon is a folder, the applications are an explorer and an archiver (compression). When the kind of icon is JPG (JPEG), the applications are an image viewer and image editing software. When the kind of icon is MP3, the applications are music reproducing software and music editing software. When the kind of icon is MP4, the applications are moving picture reproducing software, moving picture editing software, and a transcoder. When the kind of icon is text, the applications are a word processor and printing. When the kind of icon is an archive, the applications are an archiver (decompression) and a browser.

The generating unit 35 generates an application list including application candidates to be started in order to open an object in the selected region according to the attribute of the selected region determined by the determining unit 33. For example, when the detecting unit 31 detects a selection operation for selecting the selected region displayed in the retention region 15 using the second touch panel unit 14, the generating unit 35 generates an application list corresponding to the attribute of the selected region with reference to the application list table stored in the application list table storage unit 21.

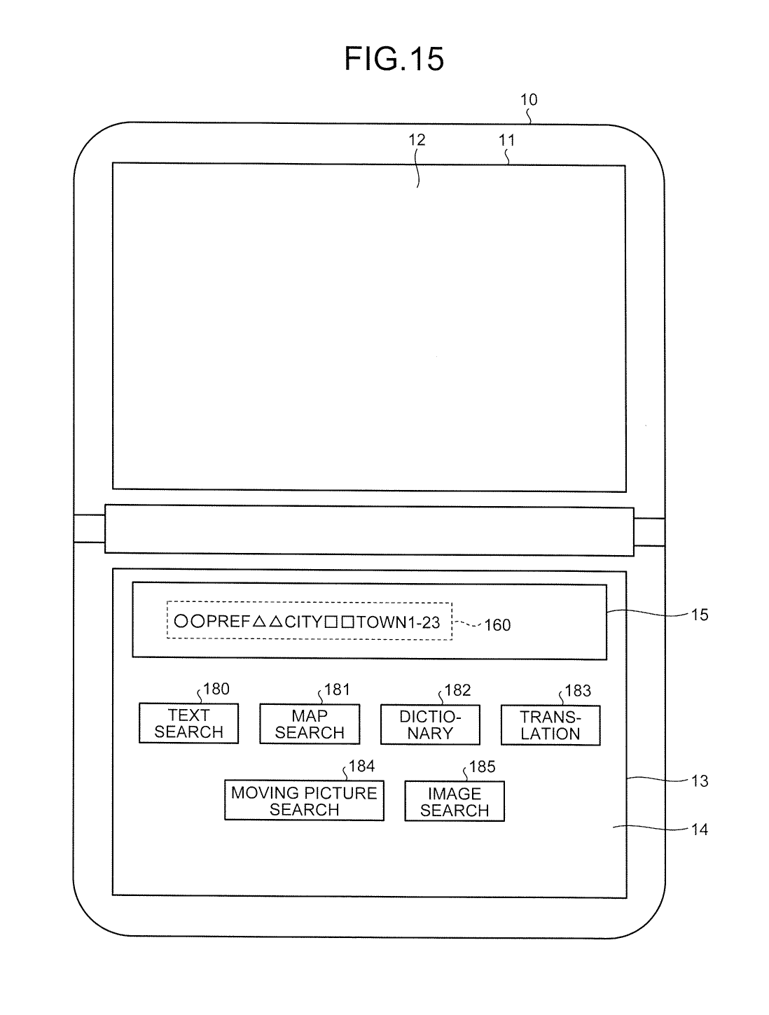

Next, the display control unit 37 will be described again. The display control unit 37 displays the application list generated by the generating unit 35 on the second display unit 13. Specifically, when the detecting unit 31 detects a selection operation for selecting the selected region displayed in the retention region 15 using the second touch panel unit 14, the display control unit 37 displays the application list generated by the generating unit 35 on the second display unit 13. For example, as shown in FIG. 15, when the detecting unit 31 detects a selection operation for selecting the text 160 displayed in the retention region 15, the display control unit 37 displays the application list on the second display unit 13. In this embodiment, since the application list of the text 160 is displayed, the applications included in the application list are a text search 180, a map search 181, a dictionary 182, translation 183, a moving picture search 184, and an image search 185.

Next, the application storage unit 23 will be described. The application storage unit 23 stores therein application software.

When the detecting unit 31 detects a selection operation for selecting any one of the applications included in the application list displayed on the second display unit 13 using the second touch panel unit 14, the application control unit 39 starts the selected application to open an object in the selected region. Specifically, the application control unit 39 reads the application software of the selected application from the application storage unit 23 and starts the application software. The display control unit 37 may display the application started by the application control unit 39 on the first display unit 11 or the second display unit 13.

For example, when the object in the selected region is an image file (JPG) and an image viewer is selected as the application, the display control unit 37 starts the image viewer to display the image file. When the object in the selected region is a music file (MP3) and music reproducing software is selected as the application, the display control unit 37 starts the music reproducing software to reproduce the music file. When the object in the selected region is text and translation is selected as the application, the display control unit 37 starts translation software to translate the text into another language.

The information processing apparatus 10 does not necessarily include all of the above-mentioned units as indispensable components, but some of the above-mentioned units may be omitted.

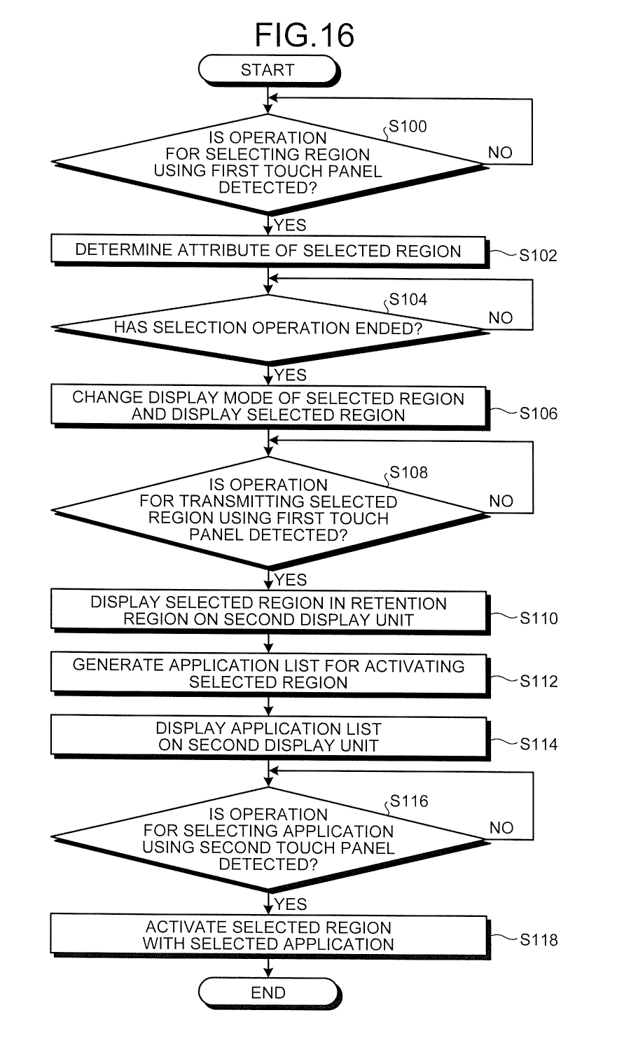

FIG. 16 is a flowchart illustrating an example of the procedure of a selection region starting process of the information processing apparatus 10 according to the first embodiment.

First, the detecting unit 31 waits until a selection operation for selecting a region of the screen displayed on the first display unit 11 using the first touch panel unit 12 is detected (No in Step S100).

When the detecting unit 31 detects the selection operation (Yes in Step S100), the determining unit 33 determines the attribute of the selected region (Step S102).

Then, the detecting unit 31 waits until the selection operation for selecting a region of the screen displayed on the first display unit 11 using the first touch panel unit 12 ends (No in Step S104).

When the detecting unit 31 detects that the selection operation ends (Yes in Step S104), the display control unit 37 changes the display mode of the selected region and displays the selected region on the first display unit 11 (Step S106).

Then, the detecting unit 31 waits until a transmission operation for transmitting the selected region to the second display unit 13 using the first touch panel unit 12 is detected (No in Step S108). When the detecting unit 31 does not detect the transmission operation within a predetermined period of time, the selection of the region is cancelled.

When the detecting unit 31 detects the transmission operation (Yes in Step S108), the display control unit 37 displays the selected region in the retention region 15 displayed on the second display unit 13 (Step S110).

Then, the generating unit 35 generates an application list including application candidates for activating the selected region according to the selected region determined by the determining unit 33 (Step S112).

Then, the display control unit 37 adjusts the display order of the application list generated by the generating unit 35 and displays the adjusted application list on the second display unit 13 (Step S114).

Then, the detecting unit 31 waits until a selection operation for selecting any one of the applications included in the application list displayed on the second display unit 13 using the second touch panel unit 14 is detected (No in Step S116).

When the detecting unit 31 detects the selection operation (Yes in Step S116), the application control unit 39 activates the selected region with the selected application (Step S118).

As described above, in the information processing apparatus 10 according to the first embodiment, the first touch panel unit 12 is used to transmit the selected region displayed on the first display unit 11 to the second display unit 13, and the second touch panel unit 14 is used to select a desired application for activating the selected region. Therefore, according to the information processing apparatus 10 according to the first embodiment, it is possible to effectively use a two-screen touch panel display to activate the selected region using a desired application with a simple (intuitive) operation. As a result, it is possible to improve operability. In particular, according to the information processing apparatus 10 according to the first embodiment, since data is moved between a plurality of screens by the transmission operation, it is possible to improve operability.

### Second Embodiment

In a second embodiment, an example of performing a selected region transmitting operation to select an application and activating a selected region will be described. The difference between the first embodiment and the second embodiment will be mainly described below. Components having the same functions as those in the first embodiment are denoted by the same reference numerals as those in the first embodiment and a description thereof will be omitted.

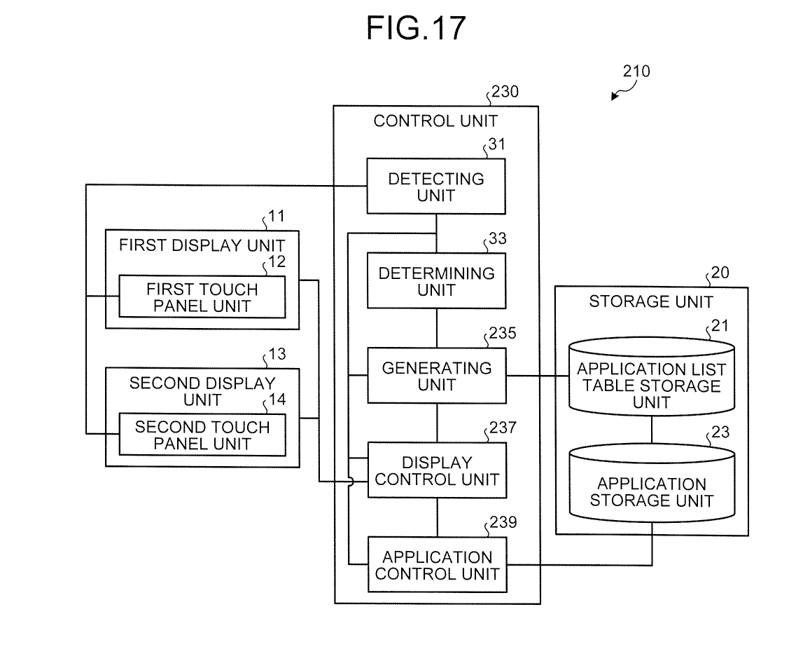

FIG. 17 is a block diagram illustrating an example of the structure of an information processing apparatus 210 according to the second embodiment. The information processing apparatus 210 according to the second embodiment differs from the information processing apparatus 10 according to the first embodiment in the processes of a generating unit 235, a display control unit 237, and an application control unit 239 of a control unit 230.

When the detecting unit 31 detects that a selection operation for selecting a region of the screen displayed on the first display unit 11 using the first touch panel unit 12 has ended, the generating unit 235 generates an application list including application candidates to be started in order to open an object in the selected region according to the attribute of the selected region determined by the determining unit 33.

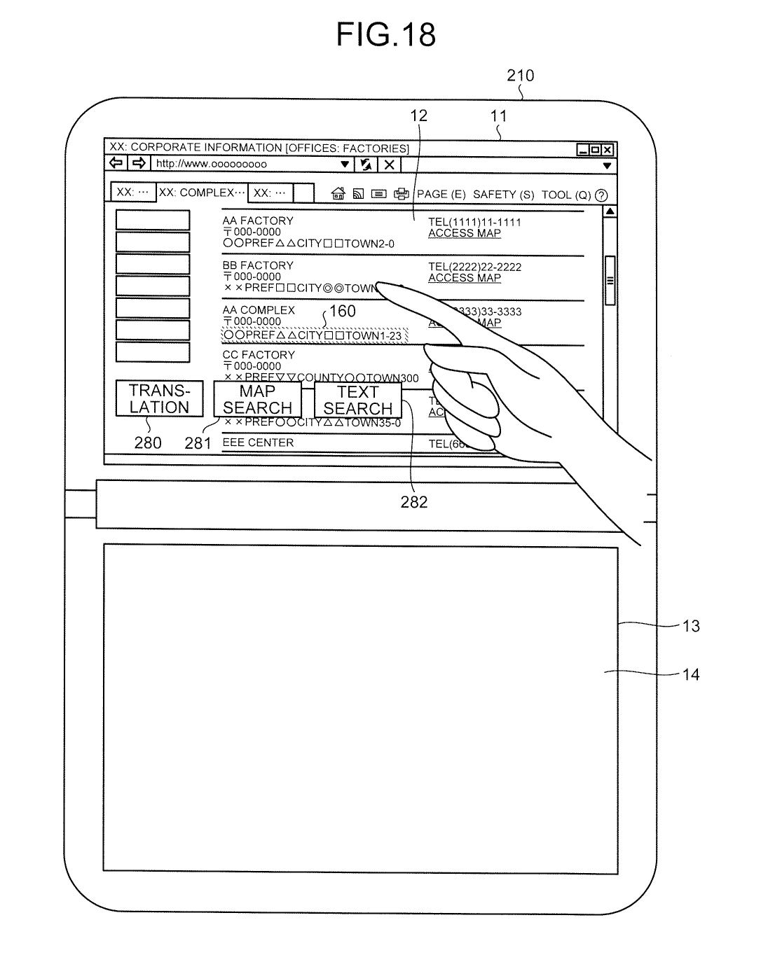

When the detecting unit 31 detects that the selection operation for selecting a region of the screen displayed on the first display unit 11 using the first touch panel unit 12 has ended, the display control unit 237 displays the application list generated by the generating unit 235 around the selected region. For example, as shown in FIG. 18, the display control unit 237 displays translation 280, a map search 281, and a text search 282 as applications around text 160 (below the text 160 in the example shown in FIG. 18). Any number of applications may be displayed around the selected region. It is preferable that a total of eight applications be displayed in terms of the convenience of use. That is, three applications may be displayed above the text, two applications may be displayed beside the text, and three applications may be displayed below the text. However, the embodiment is not limited thereto.

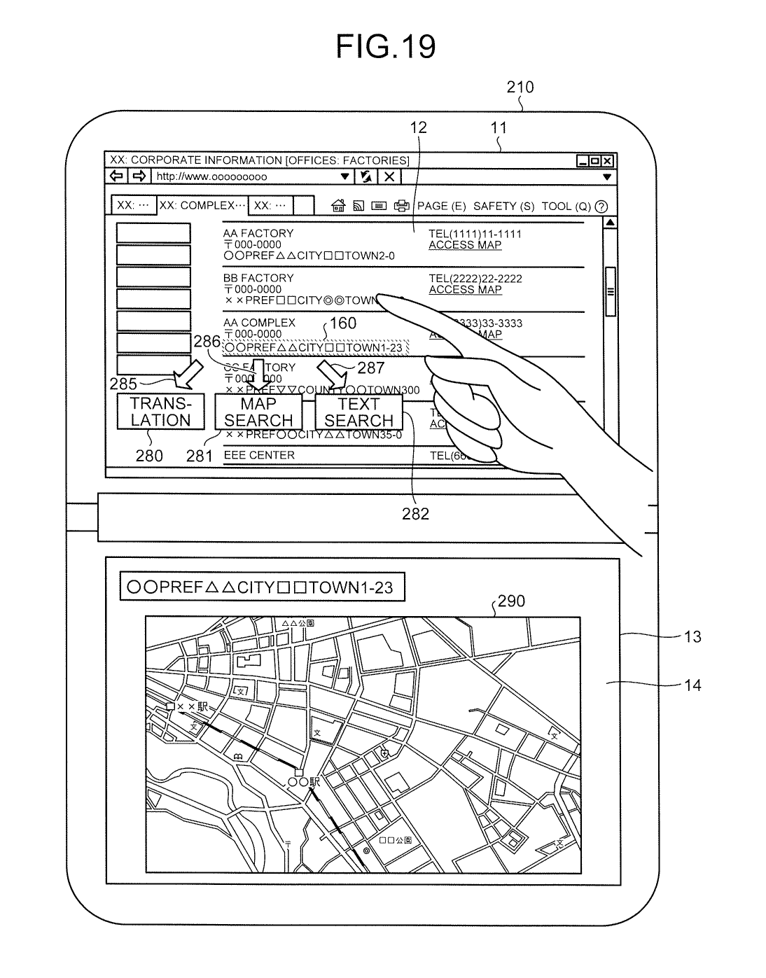

When the detecting unit 31 detects an operation for transmitting the selected region using the first touch panel unit 12, the application control unit 239 starts an application that is disposed in a direction to which the selected region is transmitted to open an object in the selected region. For example, as shown in FIG. 19, when the detecting unit 31 detects an operation of transmitting the selected region in the direction of an arrow 286, the application control unit 239 starts the map search 281 and opens the text 160. Then, as shown in FIG. 19, the display control unit 237 displays a map 290 obtained by starting the map search 281 and opening the text 160 on the second display unit 13. When the detecting unit 31 detects an operation for transmitting the selected region in the direction of an arrow 285, the display control unit 237 starts the translation 280 and opens the text 160. When the detecting unit 31 detects an operation for transmitting the selected region in the direction of an arrow 287, the display control unit 237 starts the text search 282 and opens the text 160. In the second embodiment, the selected region is activated on the second display unit 13. However, the selected region may be activated on the first display unit 11.

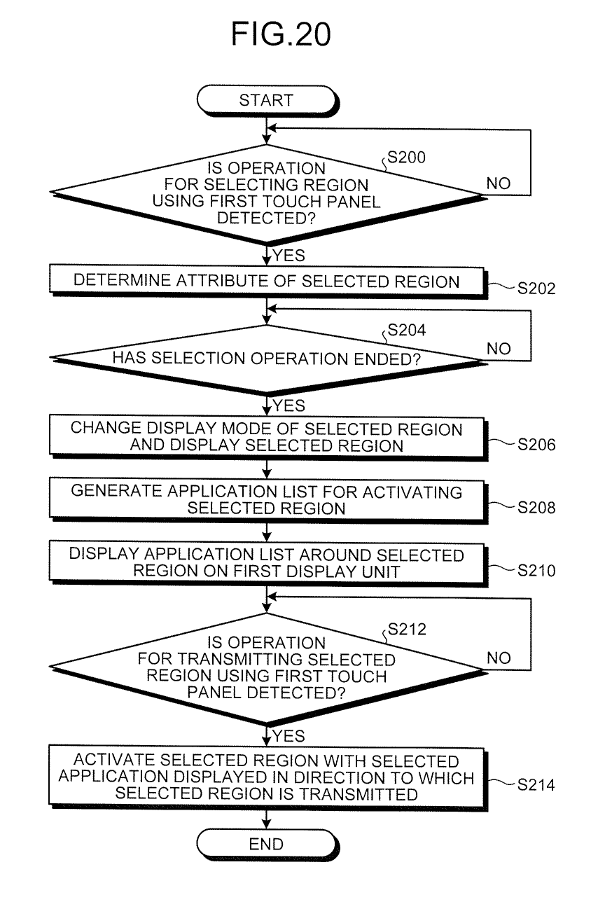

FIG. 20 is a flowchart illustrating an example of the procedure of a selected region activating process of the information processing apparatus 210 according to the second embodiment.

First, Steps S200 to S206 are the same as Steps S100 to S106 in the selected region activating process shown in FIG. 16.

Then, the generating unit 235 generates an application list including application candidates for activating the selected region according to the attribute of the selected region determined by the determining unit 33 (Step S208).

Then, the display control unit 237 displays the application list generated by the generating unit 235 around the selected region (Step S210).

Then, the detecting unit 31 waits until an operation for transmitting the selected region using the first touch panel unit 12 is detected (No in Step S212). When the detecting unit 31 does not detect the transmission operation within a predetermined period of time, the selection of the region is cancelled.

When the detecting unit 31 detects the transmission operation (Yes in Step S212), the application control unit 239 activates the selected region on the second display unit with the application disposed in the direction to which the selected region is transmitted (Step S214).

As described above, in the information processing apparatus 210 according to the second embodiment, the first touch panel unit 12 is used to transmit the selected region displayed on the first display unit 11 in a predetermined direction, and the application disposed in the direction in which the selected region is transmitted is used to activate the selected region on the second display unit 13. Therefore, according to the information processing apparatus 210 of the second embodiment, it is possible to effectively use a two-screen touch panel display to activate a selected region using a desired application with a simple (intuitive) operation. In particular, in the information processing apparatus 210 according to the second embodiment, since data is moved between a plurality of screens by the transmission operation, it is possible to improve operability.

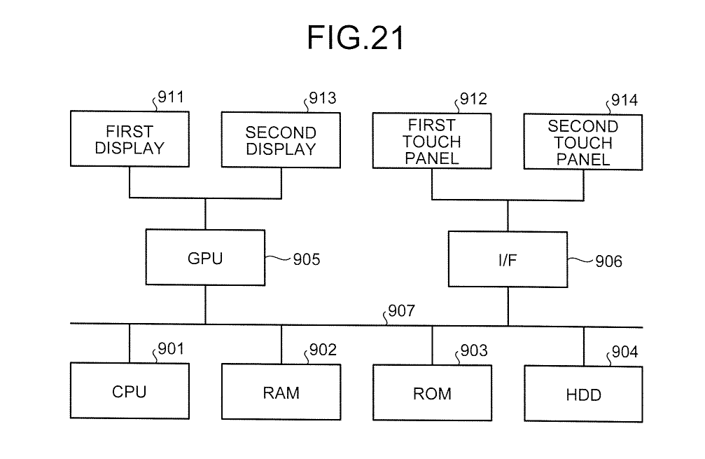

FIG. 21 is a block diagram illustrating an example of the hardware configuration of the information processing apparatuses according to the first and second embodiments. In the information processing apparatuses according to the first and second embodiments, control devices, such as a CPU 901 and a GPU 905, storage devices, such as a RAM 902 and a ROM 903, an external storage device, such as an HDD 904, and an I/F 906 are connected to one another through a bus 907. In addition, a first display 911 and a second display 913 are connected to the GPU 905, and a first touch panel 912 and a second touch panel 914 are connected to the I/F 906. As such, the information processing apparatuses according to the first and second embodiments have the hardware configuration using a general computer.

Modifications

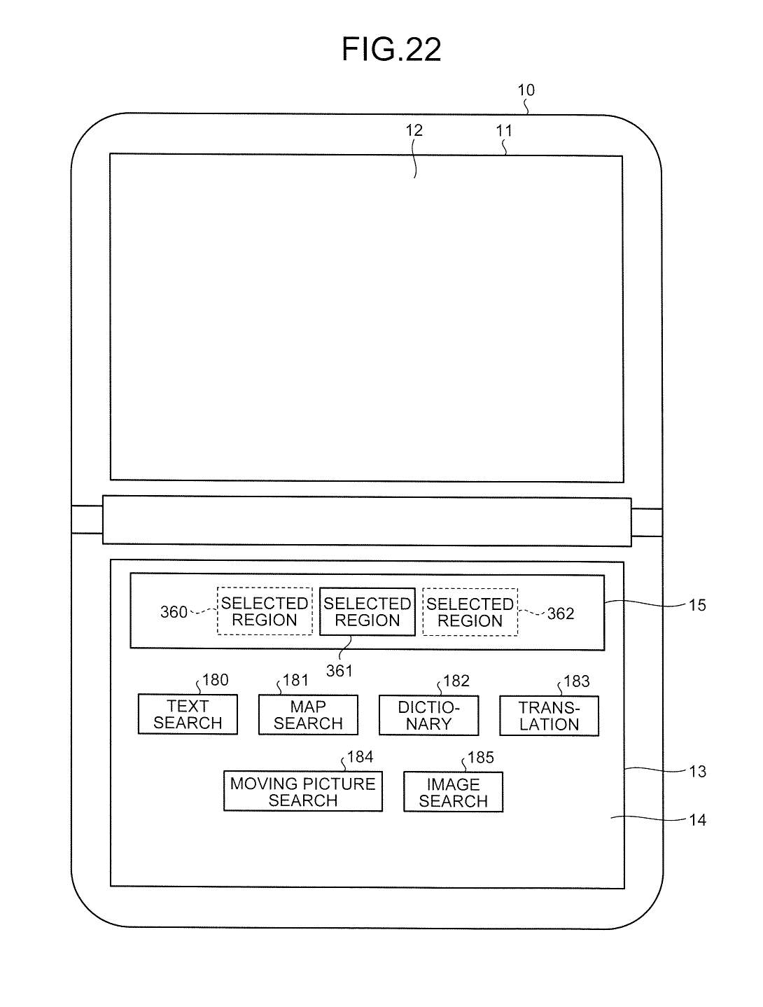

In the first embodiment, one selected region is displayed in the retention region 15 displayed on the second display unit 13. Alternatively, a plurality of selected regions may be displayed in the retention region 15. In this case, when the detecting unit 31 detects a transmission operation for transmitting a new selected region to the second display unit 13 using the first touch panel unit 12, the display control unit 37 displays the selected region and the new selected region in the retention region 15. In an example shown in FIG. 22, selected regions 360 to 362 are displayed in the retention region 15, and the selected region 361 is selected. Since the attribute of the selected region 361 is text, the applications included in an application list are the text search 180, the map search 181, the dictionary 182, the translation 183, the moving picture search 184, and the image search 185.

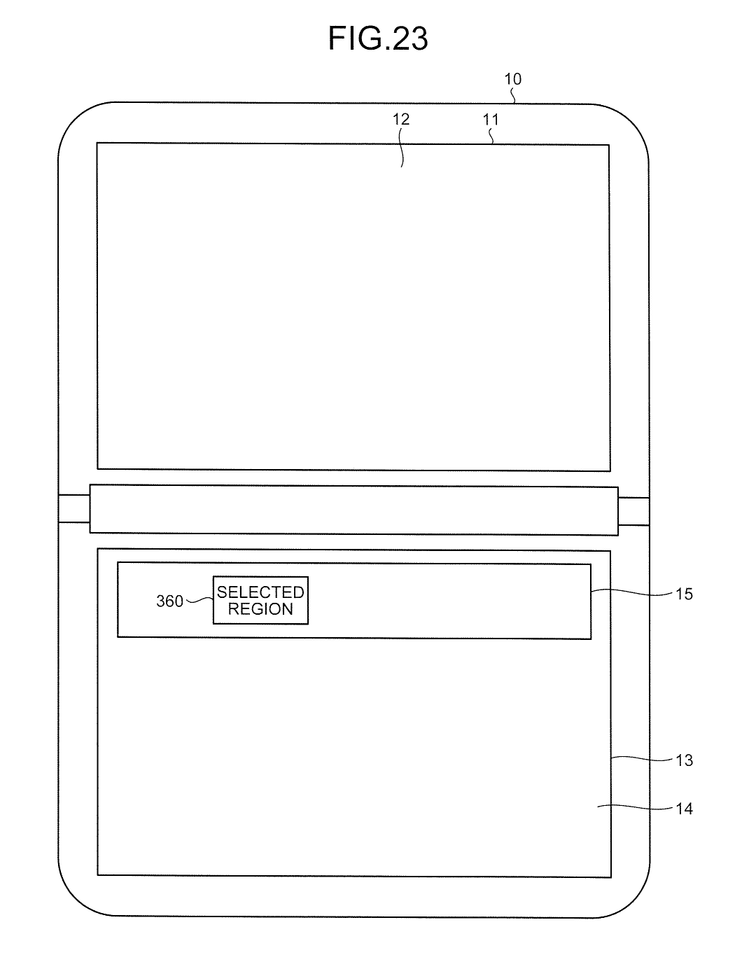

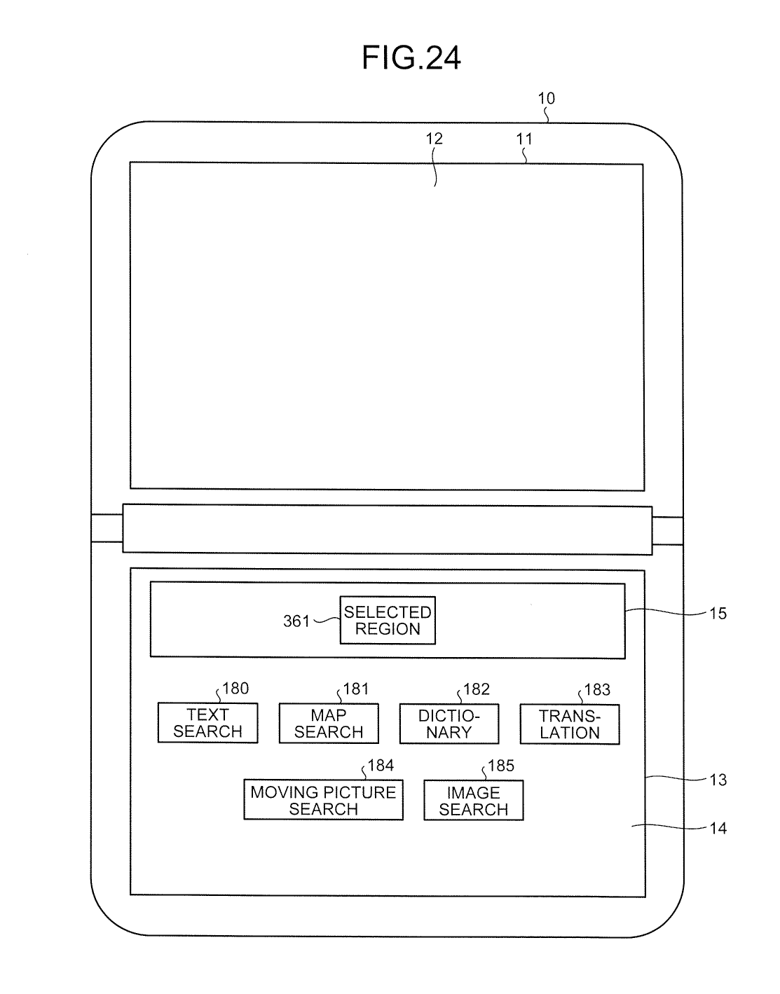

When the detecting unit 31 detects the transmission operation for transmitting a new selected region to the second display unit 13 using the first touch panel unit 12, the display control unit 37 may delete the selected region displayed in the retention region 15 and display the new selected region in the retention region 15. In an example shown in FIG. 23, the selected region 360 is displayed in the retention region 15. When the detecting unit 31 detects a transmission operation for transmitting the new selected region 361 to the second display unit 13 using the first touch panel unit 12, the selected region 360 is deleted from the retention region 15 and the new selected region 361 is displayed in the retention region 15, as shown in FIG. 24.

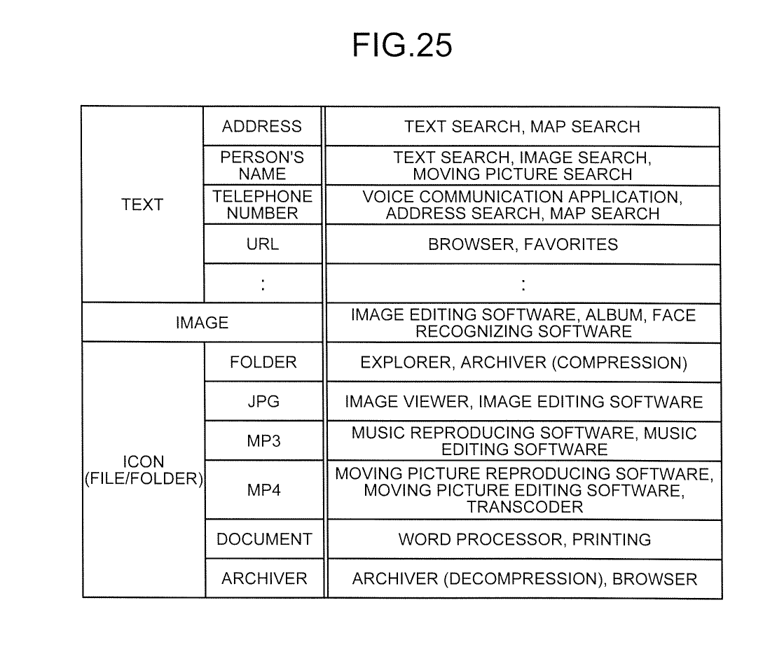

In the application list table according to each of the above-described embodiments, the kind of text is not distinguished. However, the kind of text may be distinguished to set the application list table. In this case, when the determining unit 33 determines the attribute to be text, natural language processing may be performed to determine the kind of text. In an example shown in FIG. 25, text is classified into, for example, an address, a person's name, a telephone number, and a URL. When the kind of text is an address, the applications included in the application list are a text search and a map search. When the kind of text is a person's name, the applications included in the application list are a text search, an image search, and a moving picture search. When the kind of text is a telephone number, the applications included in the application list are a voice communication application, an address search, and a map search. When the kind of text is a URL, the applications included in the application list are a browser and favorites.

For example, the functions of the information processing apparatuses according to the first and embodiments may be implemented by executing a program.

In this case, the programs executed by the information processing apparatuses according to the first and second embodiments are stored as files of an installable format or an executable format in computer-readable storage media, such as a CD-ROM, a CD-R, a memory card, a DVD (Digital Versatile Disk), and a flexible disk (FD) and are provided as computer program products. The programs executed by the information processing apparatuses according to the first and second embodiments may be incorporated into, for example, a ROM in advance and then provided.

The programs executed by the information processing apparatuses according to the first and second embodiments may be stored in a computer that is connected to a network, such as the Internet, downloaded from the computer through the network, and then provided. In addition, the programs executed by the information processing apparatuses according to the first and second embodiments may be provided or distributed through a network such as the Internet.

The programs executed by the information processing apparatuses according to the first and second embodiments have a module structure for implementing the functions of each of the above-mentioned units on the computer. As actual hardware, the CPU 901 reads the program from, for example, the HDD 904, temporarily stores it into the RAM 902, and executes the program to implement the function of each unit on the computer.

As described above, according to the first and second embodiments and the modifications, it is possible to improve operability of operation involving a plurality of screens.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first display;
a first touch panel above a display surface of the first display;
a second display;
a second touch panel above a display surface of the second display;
a detecting unit configured to detect an operation input to the first touch panel and the second touch panel;
a determining unit configured to, when the detecting unit detects as the operation input a selection operation for selecting a region of a screen displayed on the first display using the first touch panel, determine kind of an object included in a selected region;
a generating unit configured to generate an application list including application candidates to be started in order to open the object according to the kind of the object;
a display control unit configured to, when the detecting unit detects as the operation input a transmission operation for transmitting the selected region to the second display using the first touch panel, display the application list on the second display; and
an application control unit configured to, when the detecting unit detects as the operation input a selection operation for selecting any one of the applications included in the application list using the second touch panel, start a selected application to open the object.

2. The apparatus according to claim 1, wherein
when the detecting unit detects the transmission operation, the display control unit displays the selected region in a retention region displayed on the second display,
when the detecting unit detects as the operation input a selection operation for selecting the selected region displayed in the retention region using the second touch panel, the generating unit generates the application list, and
the display control unit displays the application list on the second display.

3. The apparatus according to claim 2, wherein
when the detecting unit detects as the operation input a transmission operation for transmitting a new selected region to the second display using the first touch panel, the display control unit displays the selected region and the new selected region in the retention region.

4. The apparatus according to claim 2, wherein
when the detecting unit detects as the operation input a transmission operation for transmitting a new selected region to the second display using the first touch panel, the display control unit deletes the selected region displayed in the retention region and displays the new selected region in the retention region.

5. An information processing apparatus comprising:
a first display;
a first touch panel above a display surface of the first display;
a second display;
a second touch panel above a display surface of the second display;
a detecting unit configured to detect an operation input to the first touch panel and the second touch panel;
a determining unit configured to, when the detecting unit detects as the operation input a selection operation for selecting a region of a screen displayed on the first display using the first touch panel, determine kind of an object included in a selected region;
a generating unit configured to generate an application list including application candidates to be started in order to open the object according to the kind of the object;
a display control unit configured to display applications included in the application list around the selected region; and
an application control unit configured to, when the detecting unit detects as the operation input a transmission operation for transmitting the selected region using the first touch panel, start the application disposed in a direction to which the selected region is transmitted to open the object on the second display.

6. An information processing method comprising:
detecting an operation input to a first touch panel above a display surface of a first display and a second touch panel above a display surface of a second display;
determining, when as the operation input a selection operation for selecting a region of a screen displayed on the first display using the first touch panel is detected in the detecting, kind of an object included in a selected region;
generating an application list including application candidates to be started in order to open the object according to the kind of the object;
displaying, when as the operation input a transmission operation for transmitting the selected region to the second display using the first touch panel is detected in the detecting, the application list on the second display; and
starting, when as the operation input a selection operation for selecting any one of the applications included in the application list using the second touch panel is detected in the detecting, a selected application to open the object.

7. An information processing method comprising:
detecting an operation input to a first touch panel above a display surface of a first display and a second touch panel above a display surface of a second display;
determining, when as the operation input a selection operation for selecting a region of a screen displayed on the first display using the first touch panel is detected in the detecting, kind of an object in a selected region;
generating an application list including application candidates to be started in order to open the object according to the kind of the object;
displaying applications included in the application list around the selected region; and
starting, when as the operation input a transmission operation for transmitting the selected region using the first touch panel is detected in the detecting, the application disposed in a direction to which the selected region is transmitted to open the object on the second display.

8. A computer program product comprising a computer-readable medium having programmed instructions for processing information, wherein the instructions, when executed by a computer, cause the computer to perform:
detecting an operation input to a first touch panel above a display surface of a first display and a second touch panel above a display surface of a second display;
determining, when as the operation input a selection operation for selecting a region of a screen displayed on the first display using the first touch panel is detected in the detecting, kind of an object included in a selected region;
generating an application list including application candidates to be started in order to open the object according to the kind of the object;
displaying, when as the operation input a transmission operation for transmitting the selected region to the second display using the first touch panel is detected in the detecting, the application list on the second display; and
starting, when as the operation input a selection operation for selecting any one of the applications included in the application list using the second touch panel is detected in the detecting, a selected application to open the object.

9. A computer program product comprising a computer-readable medium having programmed instructions for processing information, wherein the instructions, when executed by a computer, cause the computer to perform:
detecting an operation input to a first touch panel above a display surface of a first display and a second touch panel above a display surface of a second display;
determining, when as the operation input a selection operation for selecting a region of a screen displayed on the first display using the first touch panel is detected in the detecting, kind of an object in a selected region;
generating an application list including application candidates to be started in order to open the object according to the kind of the object;
displaying applications included in the application list around the selected region; and
starting, when as the operation input a transmission operation for transmitting the selected region using the first touch panel is detected in the detecting, the application disposed in a direction to which the selected region is transmitted to open the object on the second display.
